(19) United States
(12) Patent Application Publication
(10) Pub. No.: US 2025/0116456 A1
(43) Pub. Date: Apr. 10, 2025

(54) CENTRIFUGAL DRYING METHOD AND CENTRIFUGAL DRYER

(71) Applicant: SUGINO MACHINE LIMITED, Namerikawa City (JP)

(72) Inventors: Hideyoshi OTANI, Namerikawa City (JP); Hiroki HAREMAKI, Namerikawa City (JP)

(21) Appl. No.: 18/900,198

(22) Filed: Sep. 27, 2024

(30) Foreign Application Priority Data
Oct. 5, 2023 (JP) 2023-173694
May 22, 2024 (JP) 2024-083288

(51) Int. Cl. F26B 5/08; F26B 11/02; F26B 11/08

(52) U.S. Cl. CPC F26B 5/08; F26B 11/022; F26B 11/08

(57) ABSTRACT

Provided is a centrifugal drying method for a workpiece having a plurality of blind holes. The centrifugal drying method includes: installing the workpiece to a turntable in a first posture in which an opening of a first blind hole among the plurality of the blind holes faces downward; and rotating the workpiece in the first posture about a rotation axis extending in a vertical direction together with the turntable.

### CROSS-REFERENCE TO RELATED APPLICATIONS

This application claims the benefit of priority to Japanese Patent Application No. 2023-173694, filed on Oct. 5, 2023, and Japanese Patent Application No. 2024-083288, filed on May 22, 2024, the entire contents of both of which are hereby incorporated by reference.

### BACKGROUND

### 1. Technical Field

The present invention relates to a centrifugal drying method and a centrifugal dryer for a workpiece to be dried having a blind hole.

### 2. Description of the Background

A cleaning and dewatering device has been proposed in which a workpiece fixed with a jig to a rotation table provided in a cleaning chamber is cleaned with air and water ejected from a blow nozzle and an ejection nozzle, and the workpiece is dewatered by the centrifugal force of the rotation table (JP H10-128524 A; hereinafter, Patent Literature 1).

### BRIEF SUMMARY

According to the cleaning and dewatering apparatus of Patent Literature 1, air blowing of a tapped hole of the workpiece is performed after cleaning, and the rotation table rotates at a high speed to dehydrate. In order to perform air blowing, it is necessary to compress the air and a large power is required. When compressed air is supplied from the factory, the amount of electric power increases due to pressure loss.

The present invention is intended to dewater an inside of a blind hole of a workpiece by centrifugal drying.

A first aspect of the present invention provides a centrifugal drying method for a workpiece having a plurality of blind holes, the centrifugal drying method including:
installing the workpiece to a turntable in a first posture in which an opening of a first blind hole among the plurality of the blind holes faces downward; and
rotating the workpiece in the first posture about a rotation axis extending in a vertical direction together with the turntable.

A second aspect of the present invention provides a centrifugal dryer for centrifugal drying a workpiece having a plurality of blind holes, the centrifugal dryer including:
a turntable configured to rotate about a rotation axis extending in a vertical direction;
a tilting table disposed on the turntable, the tilting table configured to tilt about a tilt axis extending in a horizontal direction; and
a tilting device configured to tilt the workpiece about the tilt axis between a first posture and a second posture, the first posture being a posture in which an opening of a first blind hole among the plurality of the blind holes faces downward, the second posture being a posture in which an opening of a second blind hole among the plurality of the blind holes faces downward, the second blind hole facing in a different direction from the first blind hole.

A third aspect of the present invention provides a centrifugal drying method for a workpiece having a plurality of blind holes, the centrifugal drying method including:
installing the workpiece to a turntable in a first posture in which an opening of a first blind hole among the plurality of the blind holes faces downward;
rotating the workpiece in the first posture about a rotation axis extending in a vertical direction together with the turntable;
moving a tilting device to a connection position for connecting a fourth coupling of the tilting device to a third coupling of a tilting table, and moving a second pusher to push a clamp shaft to a release position inside a hollow tilting shaft for pulling a lock body from a receiver of the turntable for a posture of the tilting table to be freely rotatable; and
moving the tilting device to a retracted position for separating the fourth coupling from the third coupling, and moving the clamp shaft to a holding position under an elastic force from an elastic body for inserting the lock body to the receiver for a posture of the tilting table to be supported.

The downward direction includes a vertically downward direction.

The turntable is rotatable while holding the tilting table in the first posture, the second posture or the third posture.

The tilt angle is, for example, 180 degrees, or 90 degrees. For example, when the second blind hole is open in a direction tilted by the first posture, the second posture may be tilted so that the second blind hole faces vertically downward direction.

The tilting device may have an advancing device. The advancing device moves the support bracket between the retracted position and the connection position.

The tilting driver may be supported on the support bracket.

The tilting device causes the tilting table to tilt to the first position, the second position, or the third position. The posture holding portion holds the tilting table in the first position, the second position, or the third positions.

The lock body may include multiple protrusions. For example, the protrusion may extend in a radial direction with respect to the tilt axis. The receiver may have multiple recesses. The receiver fits with the lock body. For example, the recess may extend in a radial direction with respect to the tilt axis. The lock body and the receiver may be couplings that couple at cylindrical end faces. The lock body and the receiver may have an end face of a portion of a cylinder centered on the tilt axis. The lock body may have convex teeth. The receiver may have concave teeth.

According to the present invention, the inside of the blind hole of the workpiece can be dewatered by centrifugal drying.

### BRIEF DESCRIPTION OF DRAWINGS

FIG. 1 is a cross-sectional view of a dryer according to a first embodiment.

FIG. 2 is a plan view of the dryer according to the first embodiment.

FIG. 3 is a perspective view of a coupling according to the first embodiment.

FIG. 4 is an enlarged view of section IV in FIG. 1.

FIG. 5 is a cross-sectional view showing a state of tilting a tilting table according to the first embodiment.

FIG. 6 is a cross-sectional view taken along line VI-VI in FIG. 1.

FIG. 7 shows a centrifugal drying test method according to Example 1.

FIG. 8 shows a centrifugal drying test method according to Example 2.

FIG. 9 is a cross-sectional view of a dryer according to a second embodiment.

FIG. 10 is an enlarged view of part X in FIG. 9.

FIG. 11 is a sectional view showing a state of tilting a tilting table according to the second embodiment.

FIG. 12 is an enlarged view of part XII in FIG. 11.

### DETAILED DESCRIPTION

### First Embodiment

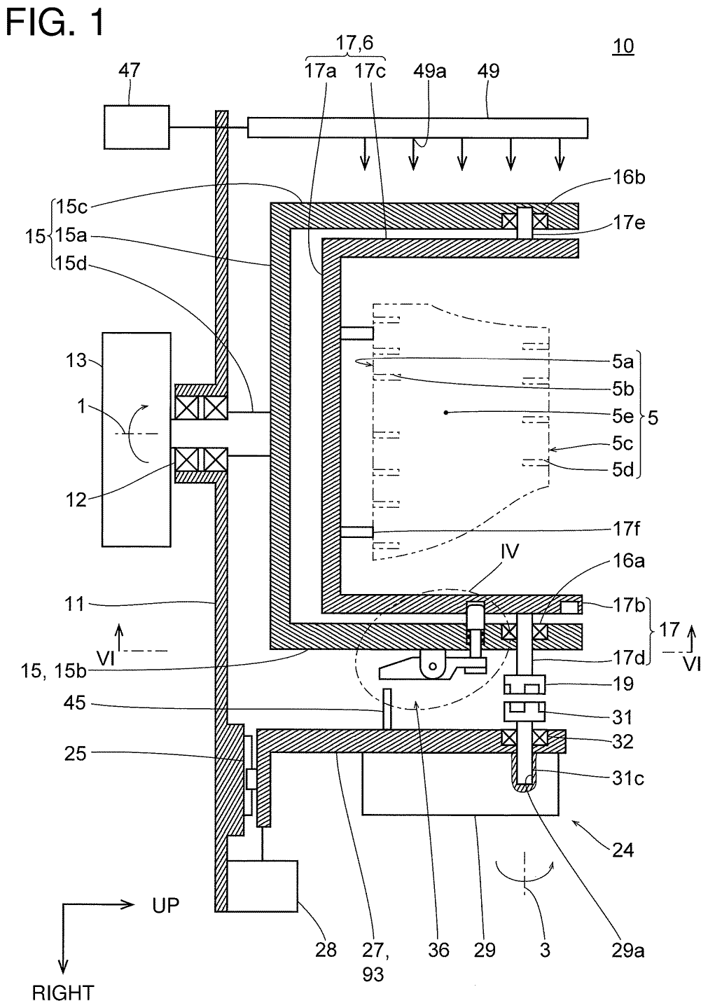

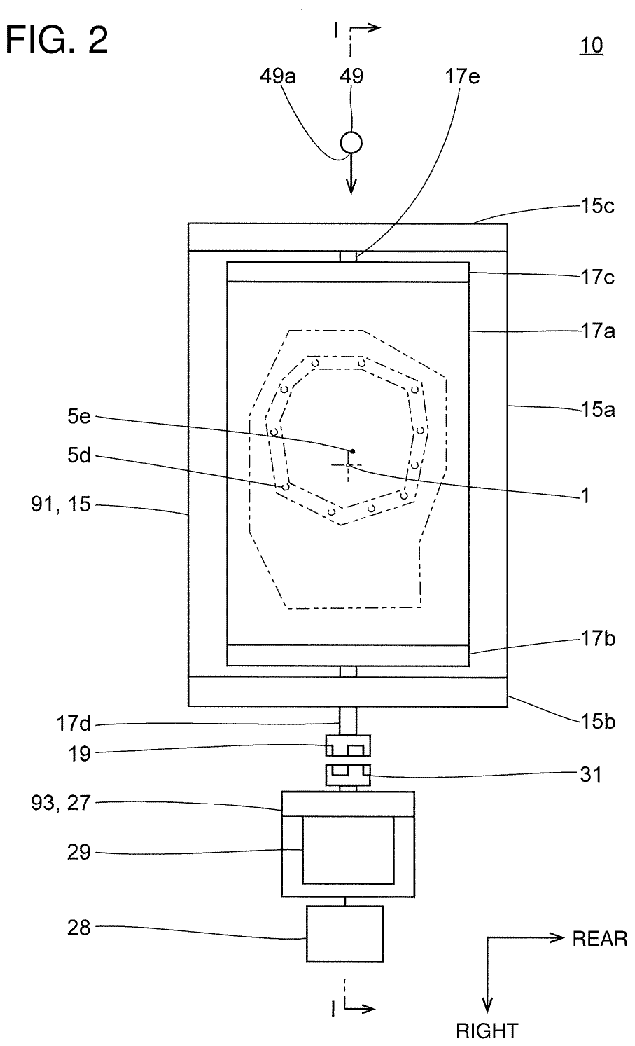

As shown in FIGS. 1 and 2, a dryer 10 according to the present embodiment includes a frame 11, a motor 13, a bearing 12, a turntable 15, a tilting table 17, a tilting device 24, a first coupling 19, a second coupling 31, a posture holding portion 36, a dry air source 47, and a nozzle 49. FIG. 1 is a cross-sectional view taken along line I-I in FIG. 2. A downward direction in FIG. 1 is a right direction of the dryer 10. A right direction in FIG. 1 is an upward direction of the dryer 10. Further, the direction from the front to the back in FIG. 1 is a rear direction of the dryer 10.

The motor 13 is disposed on a lower surface of the frame 11. The motor 13 is, for example, a PM motor. The motor 13 can stop the turntable 15 to an original position 91 (see FIG. 2). The motor 13 rotates the turntable 15 at a rotational speed of preferably 200 rpm or more preferably 250 rpm.

The turntable 15 includes a support shaft 15d, a connecting plate 15a, and side plates 15b, 15c. The support shaft 15d rotates about a rotation axis 1. The rotation axis 1 extends in a vertical direction. The connecting plate 15a, which is disposed on the upper surface of the support shaft 15d, extends horizontally. The side plates 15b, 15c, which are disposed at the left and right ends of the connecting plate 15a, extend upward and front-rear direction.

The bearing 12 is disposed on the frame 11 to support the support shaft 15d.

Trunnion bearings 16a, 16b are disposed at the upper portion of the side plates 15b, 15c, respectively.

The tilting table 17 has a top plate 17a, side plates 17b, 17c, trunnions 17d, 17e, and pins 17f. The top plate 17a extends in the front-rear direction and the lateral direction. The side plates 17b, 17c extends upward and front-rear direction from the left and right ends of the top plate 17a. The trunnions 17d, 17e are located at the upper portion of the side plates 17b, 17c, respectively. The trunnion 17d is supported by the trunnion bearing 16a to penetrate the side plate 15b. The trunnion 17e is supported by the trunnion bearing 16b. The trunnions 17d, 17e are positioned about a tilt axis 3. The pin 17f extends upward from the top plate 17a. The pin 17f supports the workpiece (workpiece to be dried) 5.

At the original position 91, the tilt axis 3 extends in the lateral direction.

The workpiece 5 has a lower surface 5a, an upper surface 5c, blind holes 5b, 5d, and a center of gravity 5e. The lower surface 5a has the blind hole (first blind hole) 5b. The upper surface 5c has the blind hole (second blind hole) 5d. Preferably, the number of blind holes 5b of the lower surface 5a is larger than the number of blind holes 5d in the upper surface 5c.

The tilting device 24 includes an advancing guide 25, a support bracket 27, an advancing device 28, and a tilting driver 29.

The advancing guide 25, which is disposed on the frame 11, extends in the lateral direction. The advancing guide 25 is, for example, a linear motion guide.

The support bracket 27 is L-shaped in a front view. The support bracket 27 is disposed on the advancing guide 25. The support bracket 27 is guided by the advancing guide 25.

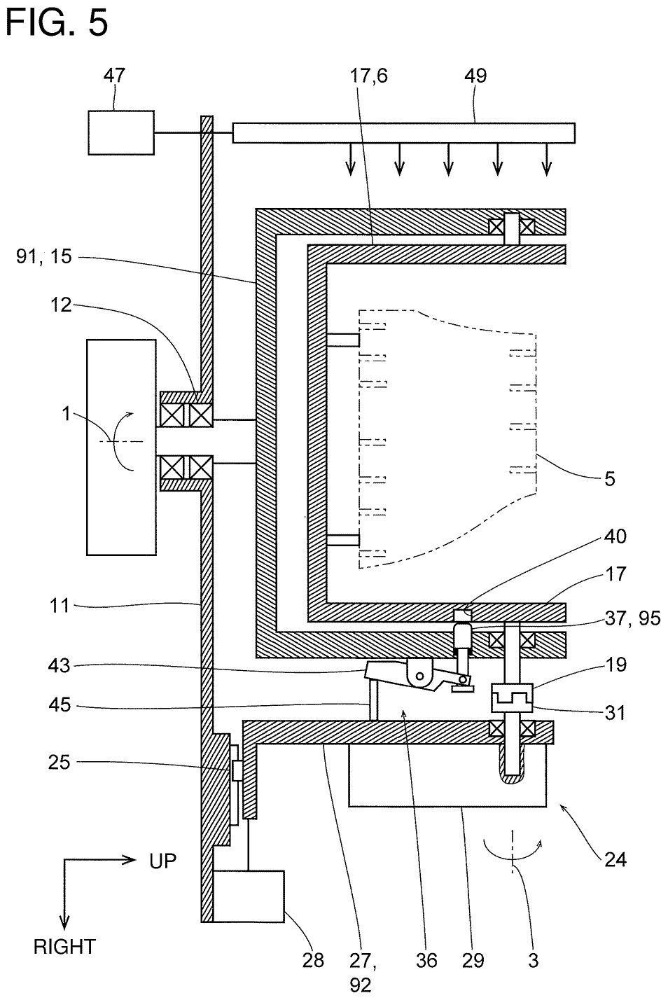

The advancing device 28 is disposed on the frame 11. The advancing device 28 is, for example, a fluid cylinder, an electric cylinder, and a servomotor and ball screw mechanism. The advancing device 28 is connected to the support bracket 27. The advancing device 28 causes the support bracket 27 to reciprocate between a retracted position 93 and a connection position 92 (see FIG. 5). When the advancing device 28 moves the support bracket 27 to the retracted position 93, the second coupling 31 is separated from the first coupling 19 to allow the turntable 15 to rotate freely.

The tilting driver 29 includes an output shaft 29a. The output shaft 29a may be a hollow shaft. The tilting driver 29 is, for example, a motor, or a rotary cylinder.

The tilting driver 29 may be a lever and a cylinder. Here, the lever extend radially from the tilt axis 3 to be connected to the output shaft 29a. The cylinder extends in the circumferential direction of the tilt axis 3 to be connected to the lever.

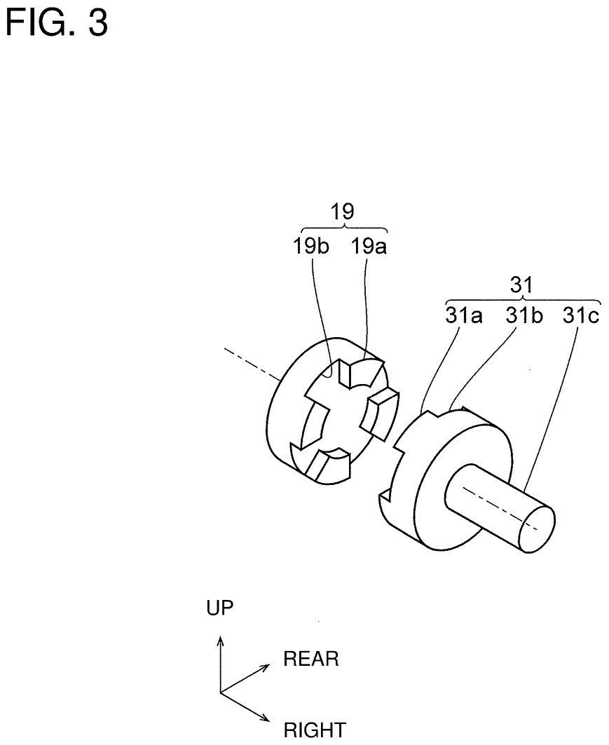

The first coupling 19 is connected to the trunnion 17d. The second coupling 31 is connected to the output shaft 29a. As shown in FIG. 3, the first coupling 19 is cylindrical. The first coupling 19 has a tab 19a and a groove 19b at its end. The tab 19a and the groove 19b are alternately arranged on the circumference. The second coupling 31 has a tab 31a, a groove 31b, and an input shaft 31c. When the support bracket 27 is at the connection position 92, the tab 31a abuts the groove 19b. The tab 19a abuts the groove 31b. Thus, the first coupling 19 and the second coupling 31 engage and rotate integrally.

The dry air source 47 is, for example, a blower. The dry air source 47 may generate hot air. The nozzle 49 has a plurality of ejection openings 49a. The ejection opening 49a is positioned toward the workpiece 5. The plurality of ejection openings 49a are arranged evenly in the vertical direction, for example.

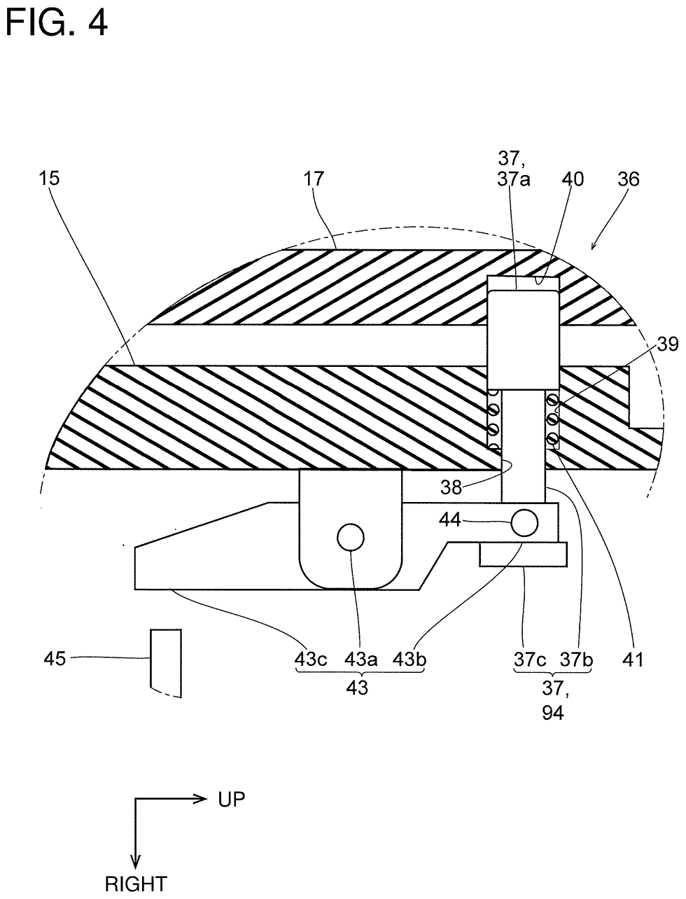

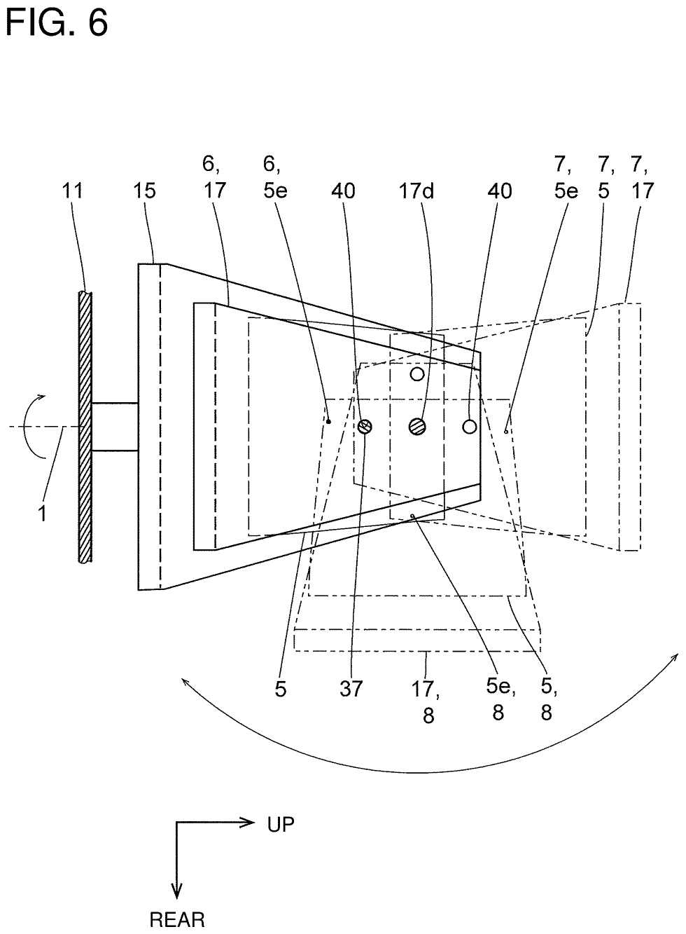

As shown in FIG. 4, the posture holding portion 36 includes a plunger chamber 39, a through hole 38, a plurality of (three in FIG. 6) pin holes 40, a plunger 37, an elastic body 41, a release lever 43, and a pusher 45.

The turntable 15 has the plunger chamber 39. The plunger chamber 39 is cylindrical extending parallel to the tilting axis 3. The plunger chamber 39 opens radially inward about the rotation axis 1. The through hole 38 extends coaxially with the plunger chamber 39. The through hole 38 penetrates from the radially outside of the side plate 15b into the plunger chamber 39.

The pin hole 40 is located on the tilting table 17. The pin hole 40 extends coaxially with the plunger chamber 39. For example, as shown in FIG. 6, the pin holes 40 are positioned in a 90 degrees rotational position about the trunnion 17d.

The plunger 37 is cylindrical. The plunger 37 passes through the plunger chamber 39 and the through hole 38. The plunger 37 includes a pin 37a, a stem 37b, and a head 37c. The pin 37a reciprocates in the lateral direction in the plunger chamber 39. The pin 37a slides into the plunger chamber 39. The head 37c is disposed radially outside of the side plate 15b with respect to the rotation axis 1. The stem 37b connects the pin 37a and the head 37c.

The elastic body 41 is disposed in the plunger chamber 39 to urge plunger 37 radially inwardly. The elastic body 41 is, for example, a compression coil spring. At this time, the plunger 37 is positioned at an insertion position 94.

The release lever 43 has a fulcrum 43a, a force point 43b, and an action point 43c. The fulcrum 43a is located in a central portion of the release lever 43 to be swingably supported by the side plate 15b. The force point 43b is located at the upper end of the release lever 43. The force point 43b is, for example, a fork-shaped for holding and supporting the stem 37b. For example, the force point 43b may support the head 37c from radially inward. The force point 43b may have a pin 44. The pin 44 supports the force point 43b in a swingable manner with respect to the head 37c and stem 37b. The action point 43c is located at the lower end of the release lever 43.

The pusher 45 is located on the support bracket 27. The pusher 45 protrudes leftward from the support bracket 27. The pusher 45 has a columnar shape.

Referring to FIGS. 1, 4, 5 and 6, a method of using the dryer 10 will be described.

As shown in FIG. 1, an operator installs the workpiece 5 to the tilting table 17. The motor 13 then rotates the turntable 15 to centrifugally dry the workpiece 5. Fluid adhered to the lower surface 5a of the workpiece 5, the side surface of the workpiece 5, and the inside of the blind hole 5b that opens in the lower surface is moved out of the workpiece 5 by the centrifugal force. During centrifugal drying, the nozzle 49 may eject dry air toward the workpiece 5.

Then, the motor 13 stops the turntable 15 at the original position 91.

Next, as shown in FIG. 5, the advancing device 28 moves the support bracket 27 to the connection position 92. At this time, the pusher 45 pushes the action point 43c of the release lever 43. The force point 43b then pulls the plunger 37 out of the pin hole 40 against the elastic force of the elastic body 41. The second coupling 31 is also coupled to the first coupling 19. The tilting driver 29 can thus tilt the tilting table 17. At this time, the plunger 37 is located at an extraction position 95.

FIG. 6 shows a state in which the tilting table 17 and the workpiece 5 are in a first posture 6 by a solid line. Further, a state where the tilting table 17 and the workpiece 5 are in a second posture 7 and a third posture 8 is indicated by two dotted chain lines, respectively. Here, the second posture 7 is a state in which the tilting table 17 is tilted by 180 degrees. The third posture 8 is a state in which the tilting table 17 is tilted by 90 degrees. As shown in FIG. 6, when the tilting table 17 is in the second posture 7 or the third posture 8, either of the three pin holes 40 faces the plunger 37.

After the tilting driver 29 has tilted the tilting table 17 to the second posture 7, the advancing device 28 moves the support bracket 27 to the retracted position 93. At this time, the elastic body 41 urges the plunger 37 in the direction of inserting it into the pin hole 40. As the pusher 45 moves away from the turntable 15, the inclination of the release lever 43 is thus returned and the plunger 37 is inserted into the pin hole 40. Further, as the support bracket 27 moves to the right, the second coupling 31 is separated from the first coupling 19. The tilting table 17 is thus supported in the second posture 7. Further, the second coupling 31 and the pusher 45 retract to the outside of a rotation radius of the tilting table 17.

The blind hole 5d located on the upper surface of the workpiece 5 (see FIG. 1) in the first posture 6 opens to the downward direction of the workpiece 5 in the second posture 7. In this state, the motor 13 rotates the turntable 15 again to centrifugally dry the workpiece 5. Gravity and centrifugal force act on the fluid in the blind hole 5d. The fluid inside the blind hole 5d thus moves out of the workpiece 5. During centrifugal drying, the nozzle 49 may eject dry air toward the workpiece 5.

The motor 13 stops the turntable 15 at the original position 91. The advancing device 28 then moves the support bracket 27 to the connection position 92. The tilting device 24 then returns the tilting table 17 to the first posture 6. Finally, the advancing device 28 moves the support bracket 27 to the retracted position 93.

In place of centrifugal drying in the second posture 7, the workpiece 5 may be centrifugally dried in the third posture 8. Further, after centrifugal drying in the second posture 7, the workpiece 5 may be further centrifugally dried in the third posture 8.

According to the drying method using the dryer 10 of the present embodiment, the blind hole 5b opening to the lower surface of the workpiece 5 and the side surface of the workpiece 5 are dried when the workpiece 5 is centrifugally dried in the first posture 6. However, the blind hole 5d that opens in the upper surface of the workpiece 5 is difficult to dry. The workpiece 5 is thus rotated 180 degrees to the second posture 7. The blind hole 5d then opens downward. Centrifugal drying in this state will dry the blind hole 5d. Further, blowing dry air by the nozzle 49 to the workpiece 5 during centrifugal drying efficiently dries the workpiece 5.

The tilting device 24 reciprocates between the connection position 92 and the retracted position 93. When the tilting device 24 at the connection position 92, the tilting table 17 is tiltable by the release lever 43 pulling the plunger 37 out of the pin hole 40. When the tilting device 24 is at the connection position 92, the second coupling 31 is then connected to the first coupling 19. The tilting device 24 can thus tilt the tilting table 17.

Further, when the tilting device 24 is moved to the retracted position 93, the release lever 43 is returned to the original position by the elastic force of the elastic body 41, and the plunger 37 is inserted into the pin hole 40. The second coupling 31 is then separated from the first coupling 19. The tilting table 17 is thus supported on the turntable 15. When the tilting device 24 is disconnected from the turntable 15, the posture of the tilting device 24 is locked.

According to the dryer 10 of the present embodiment, the tilting table 17 and the tilting device 24 can be connected or disconnected by a simple mechanism. Only when the tilting table 17 and the tilting device 24 is connected, the tilting table 17 can be tilted. Further, when the tilting device 24 is disconnected from the tilting table 17, the posture of the tilting device 24 is locked.

In Patent Literature 1, the blind holes located in the upper surface of the workpiece 5 had to be blown off by air blowing. According to the present embodiment, the blind hole 5d located on the upper surface of the workpiece 5 at the time of installation (the first posture 6) faces downward in the second posture 7 by tilting the tilting table 17. The blind hole 5d can thus be dried by centrifugal drying. Rotation drying thus allows drying of almost all of the blind holes in the workpiece 5. While generating and ejecting compressed air requires a large amount of power, the drying method using the dryer 10 of the present embodiment enables to reduce the amount of power.

Preferably, the workpiece 5 is disposed so that the center of gravity 5e of the workpiece 5 is positioned near the rotation axis 1 in the first posture 6. The tilting device 24 tilts the tilting table 17 about the tilt axis 3 by 180 degrees. Even in the second posture 7, the center of gravity 5e of the workpiece 5 is then located in the vicinity of the rotation axis 1. As the center of gravity 5e in both the first posture 6 and the second posture 7 is in the vicinity of the rotation axis 1, the inertia of the rotating portion is reduced.

When the turntable 15 is rotated, the tilting device 24 is separated from the turntable 15. This reduces the inertia of the turntable 15. Further, the tilting device 24 is connected to the frame 11 by an electric cable or air pipe. If the tilting device 24 rotates with the turntable 15, it is difficult to connect the electrical cable or air pipe. During rotation of the turntable 15, the tilting device 24 is disconnected from the turntable 15. Piping and wiring around the tilting device 24 are facilitated.

The dryer 10 according to the present embodiment includes the dry air source 47 and the nozzle 49. The nozzle 49 ejects dry air into the workpiece 5 during centrifugal drying. The workpiece 5 is thus efficiently dried. The blower consumes less power than the air compressor. Using the blower as the dry air source 47 suppresses the power consumption.

### Example 1

### Test Methods

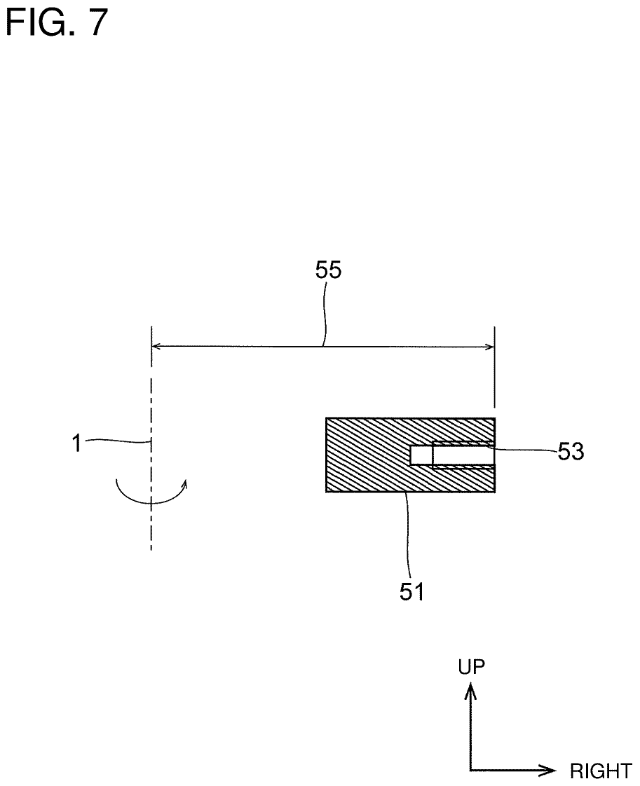

As shown in FIG. 7, a centrifugal drying test for a workpiece 51 was performed. The workpiece 51 has a female screw 53. The workpiece 51 rotates about the rotation axis 1 extending in the vertical direction. The axis of the female screw 53 intersects the rotation axis 1. The female screw 53 faces horizontally outward. A distance from a mouth of the female screw 53 to the rotation axis 1 is referred to as a rotation radius 55. The female screw 53 was filled with tap water and rotated at a constant rotational speed for 24 seconds. The drying test was performed three times for each condition.

### Test Results

Table 1 shows the test results. “A” indicates no residual water. “B” indicates that there is a slight residual water at the mouth of the female screw 53. “C” indicates that there is residual water at the bottom of the hole or entire hole. The water was removed from M10 and M12 female screws at the rotational speed of 125 min⁻¹ or more. The water was removed from M8 female screws at the rotational speed of 175 min⁻¹ or more. The water was removed from M6 female screws at the rotational speed of 250 min⁻¹ or more.

TABLE 1

| Rotation Radius | Female | Screw Depth | Rotational Speed[min⁻¹] | | | | | |
|---|---|---|---|---|---|---|---|---|
| 55[mm] | Screw | [mm] | 80 | 125 | 175 | 200 | 225 | 250 |
| 100 | M12 | 24 | B/B/B | A/A/A | A/A/A | A/A/A | A/A/A | A/A/A |
| | M10 | 20 | C/B/C | A/A/A | A/A/A | A/A/A | A/A/A | A/A/A |
| | M8 | 16 | C/C/C | C/C/A | A/A/A | A/A/A | A/A/A | A/A/A |
| | M6 | 12 | C/C/C | C/C/C | C/C/C | C/C/C | C/A/C | A/C/A |
| | M5 | 10 | C/C/C | C/C/C | C/C/C | C/C/C | C/C/C | C/A/C |
| | M4 | 8 | C/C/C | C/C/C | C/C/C | C/C/C | C/C/C | C/C/C |

### Example 2

### Test Methods

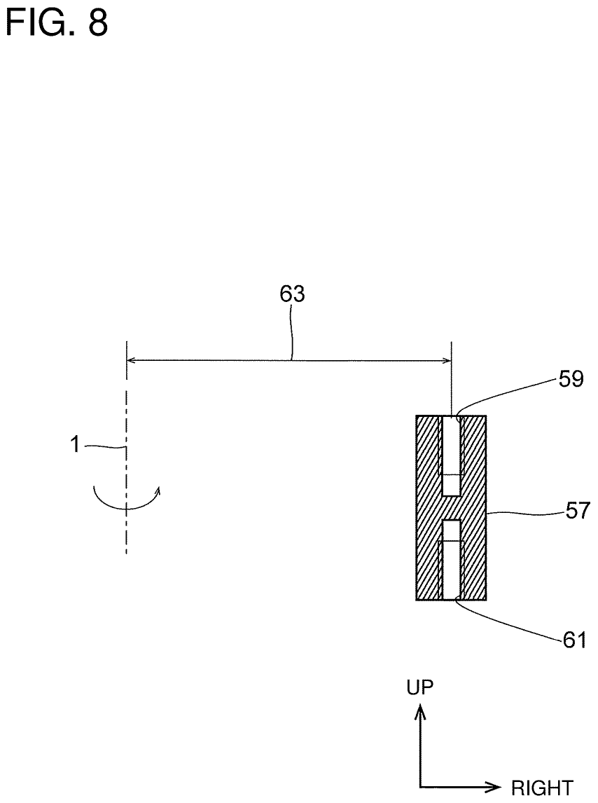

As shown in FIG. 8, the centrifugal drying test for a workpiece 57 was performed. The workpiece 57 has female screws 59, 61. The workpiece 57 rotates about the rotation axis 1 extending in the vertical direction. The female screw 59 opens vertically upward. The female screw 61 opens vertically downward. A distance from the axial center of the female screws 59, 61 to the rotation axis 1 is referred to as a rotation radius 63. The female screw 59 was filled with tap water and rotated at a constant rotational speed for 24 seconds. The female screw 61 was then filled with tap water and rotated at a constant rotational speed for 24 seconds.

### Test Results

Table 2 shows the test results of the upward-facing female screw 59. The description in the table is the same as in Example 1. The water remained in the female screw 59 under any conditions.

TABLE 2

| Rotation Radius | Female | Screw Depth | Rotational Speed[min⁻¹] | | | | | |
|---|---|---|---|---|---|---|---|---|
| 63[mm] | Screw | [mm] | 80 | 125 | 175 | 200 | 225 | 250 |
| 140 | M12 | 24 | C | C | C | C | C | C |
| 115 | M10 | 20 | C | C | C | C | C | C |
| 100 | M8 | 16 | C | C | C | C | C | C |
| 100 | M6 | 12 | C | C | C | C | C | C |
| 115 | M5 | 10 | C | C | C | C | C | C |
| 140 | M4 | 8 | C | C | C | C | C | C |

Table 3 shows the test results of the downward-facing female screw 61. Regarding M12, the water fell prior to rotating the workpiece 57. This is indicated by “-”. The water was removed from M10 at the rotational speed of 80 min⁻¹ or more. The water was removed from M8 at the rotational speed of 125 min⁻¹ or more. The water was removed from M6 and M5 at the rotational speed of 200 min⁻¹ or more. The water was removed from M4 at the rotational speed of 250 min⁻¹.

TABLE 3

| Rotation Radius | Female | Screw Depth | Rotational Speed[min⁻¹] | | | | | |
|---|---|---|---|---|---|---|---|---|
| 63[mm] | Screw | [mm] | 80 | 125 | 175 | 200 | 225 | 250 |
| 140 | M12 | 24 | — | — | — | — | — | — |
| 115 | M10 | 20 | A | A | A | A | A | A |
| 100 | M8 | 16 | C | A | A | A | A | A |
| 100 | M6 | 12 | C | C | C | A | A | A |
| 115 | M5 | 10 | C | C | C | A | A | A |
| 140 | M4 | 8 | C | C | C | C | C | A |

In the sensory tests described above, the inventor first found that rotational drying was possible for the downward-facing blind hole (female screw). The rotational speed is preferably more than 200 min⁻¹, and more preferably more than 250 min⁻¹.

### Second Embodiment

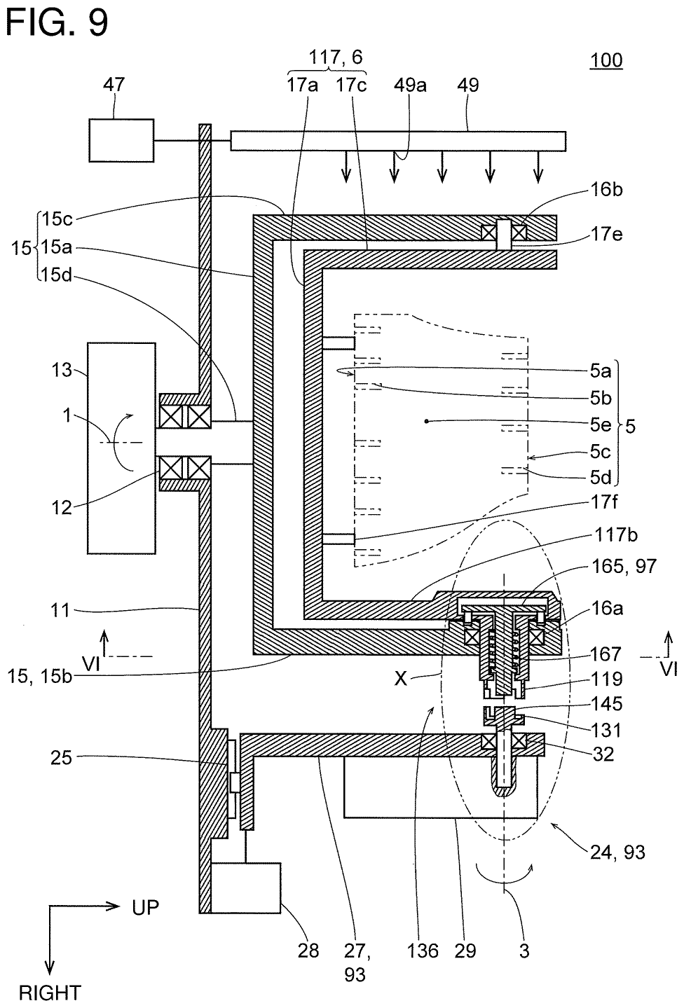

As shown in FIG. 9, a dryer 100 according to the present embodiment includes a tilting table 117, a third coupling 119, a fourth coupling 131, and a posture holding portion 136 instead of the tilting table 17, the first coupling 19, the second coupling 31, and the posture holding portion 36 of the dryer 10 according to the first embodiment. The other configurations of the dryer 100 are substantially the same as the dryer 10 of the first embodiment.

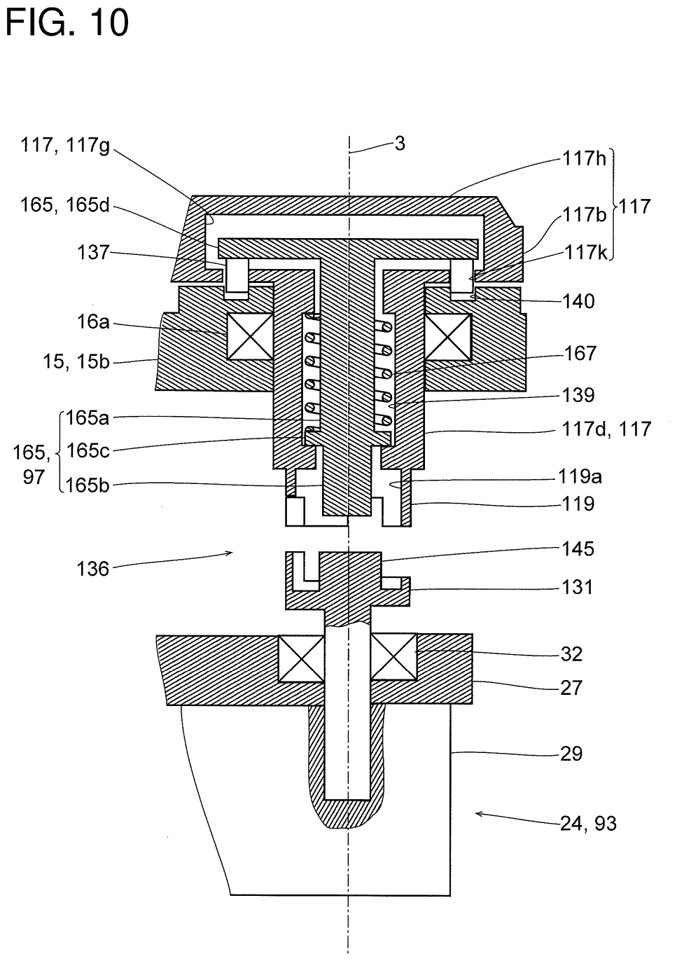

As shown in FIGS. 9 and 10, the tilting table 117 includes a top plate 17a, a side plate 117b, 17c, a trunnion (hollow tilting shaft) 117d, 17e, pins 17f, a clamp chamber 117g, a cover 117h, and a through-hole 117k. Hereinafter, as viewed from the rotation axis 1, the radial outer direction (downward in FIG. 10) is referred to as a centrifugal direction and the radial inner direction (upward in FIG. 10) is referred to as a centripetal direction. Further, a radial direction as viewed from the tilt axis 3 is simply referred to as a radial direction.

The trunnion 117d, which is hollow cylindrical, extends along the tilt axis 3. The trunnion 117d has a spring chamber 139. The spring chamber 139 is cylindrical about the tilt axis 3. The spring chamber 139 opens in the centrifugal direction of the trunnion 117d.

The clamp chamber 117g is disposed on the centripetal side of the side plate 117b. The clamp chamber 117g may be opened to the centripetal side of the side plate 117b. The clamp chamber 117g is a disc-like shape centered on the tilt axis 3. The clamp chamber 117g is connected to the spring chamber 139.

The cover 117h covers an opening of the clamp chamber 117g. The cover 117h is fastened to the side plate 117b.

The through-hole 117k extends parallel to the tilt axis 3. The through-hole 117k penetrates the side plate 117c in the centrifugal direction from the clamp chamber 117g. A plurality of (e.g., four) through-holes 117k may be disposed. The through-holes 117k are arranged in rotational symmetry (e.g., four-fold rotational symmetry) with respect to the tilt axis 3.

The third coupling 119, which has a through-hole 119a, is hollow cylindrical. The through-hole 119a is connected to the spring chamber 139.

The fourth coupling 131 is substantially the same as the second coupling 31 of the first embodiment.

As shown in FIG. 10, the posture holding portion 136 includes a pusher 145, a clamp shaft 165, a lock pin (lock body) 137, a compression coil spring (elastic body) 167, and a lock hole (receiver) 140.

The pusher 145, which is cylindrical, is disposed radially inside of the fourth coupling 131. The pusher 145 may protrude from the fourth coupling 131 in the centripetal direction. The pusher 145 moves integrally with the fourth coupling 131.

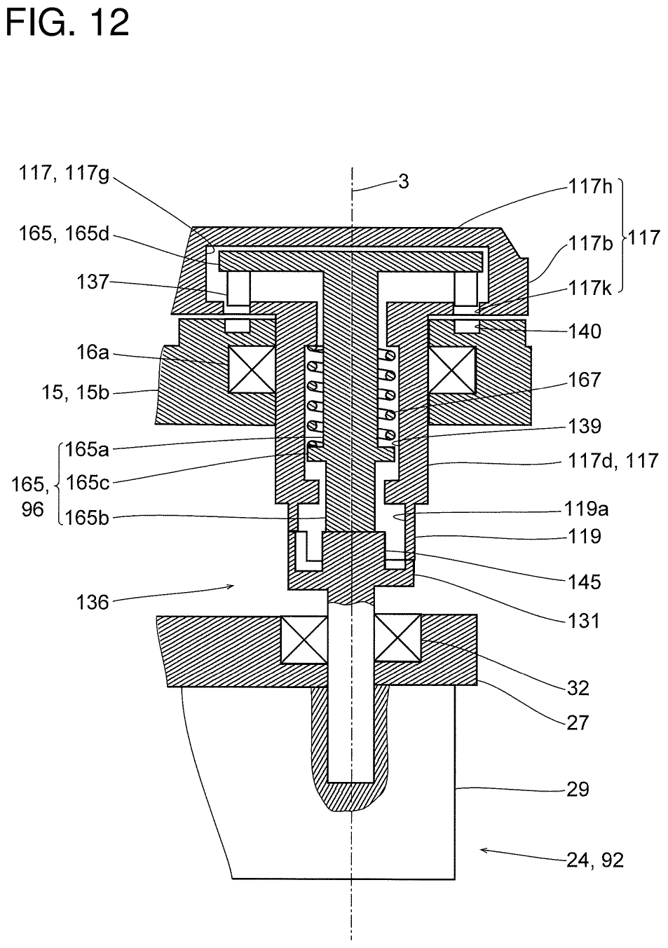

The clamp shaft 165 includes a reciprocating shaft 165a, an abutment 165b, a stopper 165c, and a flange 165d. The clamp shaft 165 is a rotating body about the tilt axis 3. The reciprocating shaft 165a and the stopper 165c are disposed inside the spring chamber 139. The clamp shaft 165 reciprocates between a centripetally release position 96 (see FIG. 12) and a centrifugally holding position 97. The stopper 165c protrudes radially outward from the outer diameter of the reciprocating shaft 165a. The stopper 165c is located at the centrifugal end of the reciprocating shaft 165a. When the tilting device 24 is located at the retracted position 93, the stopper 165c abuts against the centrifugal end of the spring chamber 139.

The abutment 165b protrudes in the centrifugal direction from the stopper 165c. The abutment 165b may protrude from the centrifugal end of the trunnion 117d. The flange 165d, which is disk-shaped, is disposed at the centripetal end of the reciprocating shaft 165a. The flange 165d is located inside the clamp chamber 117g.

The lock pin 137 is connected to the flange 165d. The lock pin 137 extends parallel to the tilt axis 3. A plurality of (e.g., four) lock pins 137 may be disposed. A plurality of lock pins 137 are arranged rotationally symmetrical (e.g., four-fold rotational symmetry) with respect to the tilt axis 3. The lock pin 137 together with the clamp shaft 165 reciprocate in the through-hole 117k.

The spring 167 is disposed between the stopper 165c and the spring chamber 139. The spring 167 urges the clamp shaft 165 in the centrifugal direction.

The lock hole 140 is located on the side plate 15b of the turntable 15. The same number of the lock holes 140 as the lock pins 137 may be arranged. The lock hole 140 extends parallel to the tilt axis 3. A plurality of (e.g., four) lock holes 140 may be provided. A plurality of lock holes 140 are arranged rotationally symmetrical (e.g., four-fold rotational symmetry) with respect to the tilt axis 3.

As shown in FIGS. 9 and 10, when the tilting device 24 is at the retracted position 93, the clamp shaft 165 moves to the holding position 97, and the lock pin 137 is inserted into the lock hole 140. This keeps the tilting angle of the tilting table 117. At this time, the turntable 15 is rotatable.

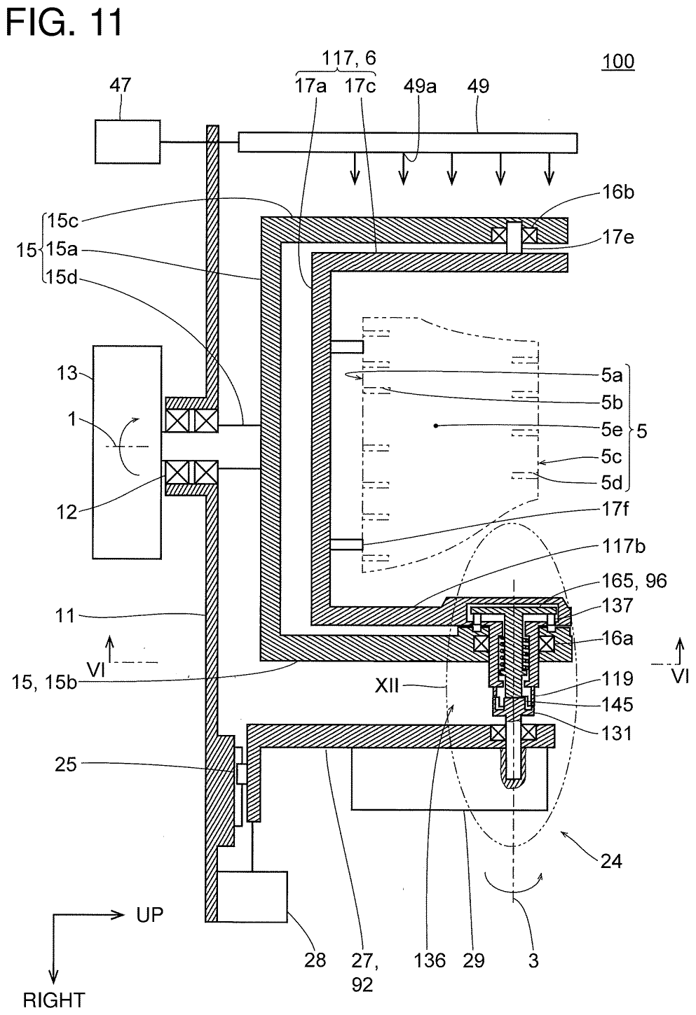

FIGS. 11 and 12 shows a state in which the tilting device 24 has moved to the connection position 92. When the tilting device 24 moves from the retracted position 93 toward the connection position 92, the fourth coupling 131 is first connected to the third coupling 119. When the tilting device 24 is further moved, the pusher 145 abuts against the abutment 165b of the clamp shaft 165. The pusher 145 then pushes the clamp shaft 165 in the centripetal direction. When the tilting device 24 reaches the connection position 92, the clamp shaft 165 moves to the release position 96. At this time, the lock pin 137 is completely pulled from the lock hole 140. This allows the tilting table 117 to tilt. At this time, the tilting driver 29 can rotate the tilting table 117 via the fourth coupling 131, the third coupling 119 and the trunnion 117d.

After the tilting device 24 rotates the tilting table 117, the tilting device 24 moves to the retracted position 93. The clamp shaft 165 moves such that the lock pin 137 is inserted into the lock hole 140. At this time, the tilting table 117 is locked. The fourth coupling 131 is then separated from the third coupling 119. When the tilting device 24 reaches the retracted position 93, the turntable 15 is rotatable.

The abutment 165b of the clamp shaft 165 may not protrude from the trunnion 117d. At this time, when the tilting device 24 is at the connection position 92, the pusher 145 passes through the through-hole 119a of the third coupling 119 to push the abutment 165b in the centripetal direction.

Instead of the lock pin 137 and the lock hole 140, a pair of Hirth coupling or a pair of Curvic coupling may be disposed. For example, the first Hirth coupling (lock body) is disposed about the tilt axis 3 on the centrifugal end face of the side plate 117b. The stem penetrating the side plate 117b connects the first Hirth coupling (lock body) and the flange 165d. The second Hirth coupling (receiver) is disposed about the tilt axis 3 on the centripetal end face of the side plate 15b. When the clamp shaft 165 is at the connection position 92, the first Hirth coupling is coupled with the second Hirth coupling to hold the tilting table 117. The first Hirth coupling may be convex teeth or concave teeth.

Alternatively, the lock pin 137 may be replaced with a portion of the convex teeth that constitute the Hirth coupling. At this time, the Hirth coupling with concave teeth may be disposed instead of the lock hole 140. The concave teeth of the Hirth coupling may have the concave teeth on the entire periphery. The locking body may be part of the concave tooth and the receptor may be part of the convex tooth.

According to the dryer of the present embodiment, the posture holding portion 136 can be configured compactly.

The present invention is not limited to the foregoing embodiments, and is capable of various modifications to the extent that it does not depart from the scope of the present invention, and all of the technical matters included in the technical ideas described in the claims are the object of the present invention. While the foregoing embodiments illustrate suitable examples, one of ordinary skill in the art can realize various alternatives, modifications, modifications or improvements from the contents disclosed herein, which are included in the technical scope of the appended claims.

### REFERENCE SIGNS LIST

1 Rotation axis
3 Tilt axis
5 Workpiece
5b, 5d Blind hole
15 Rotating table
17 Tilting table

What is claimed is:

1. A centrifugal drying method for a workpiece having a plurality of blind holes, the centrifugal drying method comprising:
installing the workpiece to a turntable in a first posture in which an opening of a first blind hole among the plurality of the blind holes faces downward; and
rotating the workpiece in the first posture about a rotation axis extending in a vertical direction together with the turntable.

2. The centrifugal drying method according to claim 1, further comprising:
tilting the workpiece about a tilt axis extending in a horizontal direction such that the workpiece is in a second posture in which an opening of a second blind hole among the plurality of the blind holes faces downward, the second blind hole facing in a different direction from the first blind hole; and
rotating the workpiece in the second posture about the rotation axis together with the turntable.

3. The centrifugal drying method according to claim 1, further comprising:
moving a tilting device to a connection position for connecting a second coupling of the tilting device to a first coupling of a tilting table while a posture of the tilting table is freely rotatable; and
moving the tilting device to a retracted position for separating the second coupling from the first coupling while inserting a plunger into a pin hole of the tilting table for supporting the posture of the tilting table.

4. The centrifugal drying method according to claim 2, further comprising:
titling the workpiece about the tilt axis such that the second blind hole is in a third posture in which the second blind hole faces in a lateral and a radially outward direction; and
rotating the workpiece in the third posture about the rotation axis together with the turntable.

5. The centrifugal drying method according to claim 1, wherein
the plurality of the blind holes are female screws having a root diameter of 6 mm or more and 10 mm or less.

6. The centrifugal drying method according to claim 1, further comprising:
blowing dry air toward the workpiece from a nozzle disposed outside of a rotation radius of the workpiece about the rotation axis.

7. A centrifugal dryer for centrifugal drying a workpiece having a plurality of blind holes, the centrifugal dryer comprising:
a turntable configured to rotate about a rotation axis extending in a vertical direction;
a tilting table disposed on the turntable, the tilting table configured to tilt about a tilt axis extending in a horizontal direction; and
a tilting device configured to tilt the workpiece about the tilt axis between a first posture and a second posture, the first posture being a posture in which an opening of a first blind hole among the plurality of the blind holes faces downward, the second posture being a posture in which an opening of a second blind hole among the plurality of the blind holes faces downward, the second blind hole facing in a different direction from the first blind hole.

8. The centrifugal dryer according to claim 7, wherein
the tilting device includes,
a first coupling located on the tilt axis,
a second coupling disposed on the tilting device, the second coupling configured to reciprocate between a connection position and a retracted position, the connection position being a position in which the second coupling is connected to the first coupling when the turntable is at an original position, the retracted position being a position in which the second coupling is separated from the first coupling for the turntable to be freely rotatable,
a tilting driver connected to the second coupling to rotate the second coupling, and
a posture holding portion disposed on the tilting device to hold the tilting table either in the first posture or in the second posture.

9. The centrifugal dryer according to claim 8, wherein
the posture holding portion allows the tilting table to rotate when the second coupling is at the connection position, and
the posture holding portion restricts the tilting table to rotate when the second coupling is at the retracted position.

10. The centrifugal dryer according to claim 8, wherein
the posture holding portion includes,
an advancing guide extending in an axial direction of the first coupling,
a support bracket disposed on the advancing guide to support the second coupling, the support bracket configured to move between the connection position and the retracted position together with the second coupling,
a pin hole located on the tilting table,
a plunger disposed on the turntable, the plunger configured to reciprocate between an insertion position and an extraction position, the insertion position being a position in which the plunger is inserted into the pin hole, the extraction position being a position in which the plunger is separated from the pin hole,
an elastic body configured to urge the plunger from the insertion position to the extraction position,
a pusher disposed on the support bracket, and
a release lever configured to pull the plunger from the pin hole when the support bracket moves to the connection position, the release lever including,
a fulcrum swingably supported by the turntable,
an action point configured to be pushed by the pusher, and
a force point configured to pull the plunger.

11. A centrifugal drying method for a workpiece having a plurality of blind holes, the centrifugal drying method comprising:
installing the workpiece to a turntable in a first posture in which an opening of a first blind hole among the plurality of the blind holes faces downward;
rotating the workpiece in the first posture about a rotation axis extending in a vertical direction together with the turntable;
moving a tilting device to a connection position for connecting a fourth coupling of the tilting device to a third coupling of a tilting table, and moving a second pusher to push a clamp shaft to a release position inside a hollow tilting shaft for pulling a lock body from a receiver of the turntable for a posture of the tilting table to be freely rotatable; and
moving the tilting device to a retracted position for separating the fourth coupling from the third coupling, and moving the clamp shaft to a holding position under an elastic force from an elastic body for inserting the lock body to the receiver for a posture of the tilting table to be supported.

12. The centrifugal drying method according to claim 11, wherein
the lock body is a lock pin, and
the receiver is a lock hole.

13. A centrifugal dryer according to claim 7, further comprising:
a hollow tilting shaft extending about the tilt axis, the hollow tilting shaft disposed on the tilting table to be supported by the turntable;
wherein the tilting device includes,
a receiver extending parallel to the tilt axis to be disposed on the turntable,
a clamp shaft disposed inside the hollow tilting shaft, the clamp shaft configured to reciprocate between a holding position and a release position along the tilt axis, the holding position located radially outside as viewed from the rotation axis, the release position located radially inside as viewed from the rotation axis,
a lock body connected to the clamp shaft, the lock body configured to be inserted into the receiver when the clamp shaft moves to the holding position, the lock body configured to be pulled out of the receiver when the clamp shaft moves to the release position,
a third coupling disposed on the hollow tilting shaft,
an elastic body configured to urge the clamp shaft from the release position to the holding position,
a fourth coupling disposed on the tilting device, the fourth coupling configured to reciprocate between a connection position and a retracted position, the connection position being a position in which the fourth coupling is connected to the third coupling when the turntable is at an original position, the retracted position being a position in which the fourth coupling is separated from the third coupling for the turntable to be freely rotatable, and
a pusher disposed radially inside of the fourth coupling with respect to the tilt axis, the pusher pushes the clamp shaft to the release position when the fourth coupling moves to the connection position.

14. The centrifugal dryer according to claim 13, wherein
the third coupling has a through-hole extending along the tilt axis, and
the clamp shaft or the pusher passes through the through-hole for the pusher to abut against the clamp shaft.

15. The centrifugal dryer according to claim 13, wherein
the lock body is a lock pin, and
the receiver is a lock hole.

16. The centrifugal drying method according to claim 2, further comprising:
moving a tilting device to a connection position for connecting a second coupling of the tilting device to a first coupling of a tilting table while a posture of the tilting table is freely rotatable; and
moving the tilting device to a retracted position for separating the second coupling from the first coupling while inserting a plunger into a pin hole of the tilting table for supporting the posture of the tilting table.

17. The centrifugal drying method according to claim 3, further comprising:
titling the workpiece about the tilt axis such that the second blind hole is in a third posture in which the second blind hole faces in a lateral and a radially outward direction; and
rotating the workpiece in the third posture about the rotation axis together with the turntable.

18. The centrifugal drying method according to claim 2, wherein
the plurality of the blind holes are female screws having a root diameter of 6 mm or more and 10 mm or less.

19. The centrifugal drying method according to claim 3, wherein
the plurality of the blind holes are female screws having a root diameter of 6 mm or more and 10 mm or less.

20. The centrifugal drying method according to claim 4, wherein
the plurality of the blind holes are female screws having a root diameter of 6 mm or more and 10 mm or less.
